(19) United States
(12) Patent Application Publication
(10) Pub. No.: US 2026/0171314 A1
(43) Pub. Date: Jun. 18, 2026

(54) MULTILAYER CERAMIC ELECTRONIC COMPONENT

(71) Applicant: TAIYO YUDEN CO., LTD., Tokyo (JP)

(72) Inventor: Atsushi IMAI, Tokyo (JP)

(73) Assignee: TAIYO YUDEN CO., LTD., Tokyo (JP)

(21) Appl. No.: 19/394,520

(22) Filed: Nov. 19, 2025

(30) Foreign Application Priority Data
Dec. 18, 2024 (JP) 2024-221892

(51) Int. Cl. H01G 4/12; H01G 4/008; H01G 4/012; H01G 4/30

(52) U.S. Cl. CPC H01G 4/1227; H01G 4/008; H01G 4/012; H01G 4/30

(57) ABSTRACT

A multilayer ceramic electronic component includes internal electrode layers facing each other in a predetermined direction, dielectric layers laminated between the internal electrode layers; and a pair of external electrodes electrically connected to the internal electrode layers. At least one of the dielectric layers includes a first crystal grain as a main component ceramic having a perovskite structure represented by a general formula ABO₃, and a second crystal grain whose main component is a barium titanate complex oxide in which an elemental ratio of barium to titanium is 0.70 or less. The second crystal grain is in contact with at least one of a pair of the internal electrode layers sandwiching the at least one of the dielectric layers.

### CROSS-REFERENCE TO RELATED APPLICATION

This application is based upon and claims the benefits of priorities of Japanese Patent Application No. 2024-221892 filed on Dec. 18, 2024, the entire contents of which are incorporated herein by reference.

### FIELD

A certain aspect of the present disclosure relates to a multilayer ceramic electronic component.

### BACKGROUND

With respect to a multilayer ceramic electronic component, for example, Japanese Unexamined Patent Application Publication No. 2024-50033 describes a multilayer ceramic capacitor. In recent years, in response to a demand for a high capacity of a multilayer ceramic electronic component, the thickness of a dielectric layer between internal electrodes in a ceramic body has been reduced so that the number of layers increases.

### SUMMARY OF THE INVENTION

According to a first aspect of the present disclosure, there is provided a multilayer ceramic electronic component including: internal electrode layers facing each other in a predetermined direction; dielectric layers laminated between the internal electrode layers; and a pair of external electrodes electrically connected to the internal electrode layers, wherein at least one of the dielectric layers includes a first crystal grain as a main component ceramic having a perovskite structure represented by a general formula ABO₃, and a second crystal grain whose main component is a barium titanate complex oxide in which an elemental ratio of barium to titanium is 0.70 or less, and wherein the second crystal grain is in contact with at least one of a pair of the internal electrode layers sandwiching the at least one of the dielectric layers.

### BRIEF DESCRIPTION OF THE DRAWINGS

FIG. 1 is a partial perspective view of a multilayer ceramic capacitor according to an embodiment of the present invention.

FIG. 2 is a sectional view taken along line A-A in FIG. 1.

FIG. 3 is a sectional view taken along the line B-B in FIG. 1.

FIG. 4A is an enlarged sectional view of the vicinity of one external electrode.

FIG. 4B is an enlarged sectional view of the vicinity of the other external electrode.

FIG. 5 is an enlarged sectional view of a part of the dielectric layer.

FIG. 6 is a view illustrating an example of a unit lattice of the perovskite structure of the first crystal grain.

FIG. 7 is a flowchart illustrating a method of manufacturing the multilayer ceramic capacitor.

FIGS. 8A and 8B are views illustrating the internal electrode forming process.

FIG. 9 is a view illustrating the lamination and crimping process.

FIG. 10 is a diagram illustrating the side margin portion.

FIG. 11A is a sectional view illustrating the internal electrode pattern and the dielectric pattern before the firing process.

FIG. 11B is a sectional view illustrating the internal electrode pattern and the dielectric pattern after the first step of the firing step.

FIG. 11C is a sectional view illustrating the dielectric layer after the second step of the firing step.

FIG. 11D is a cross-sectional view illustrating the dielectric layer in which the second crystal grains are absent.

### DETAILED DESCRIPTION

When the thickness of the dielectric layer is reduced, there is a possibility that the resistance to electrostriction or the like is lowered, and there is also a possibility that the insulation resistance (IR) is lowered due to gaps in the dielectric layer generated by the binder removal step during the manufacturing. Therefore, the reliability of the multilayer ceramic electronic component may be reduced.

### Embodiment

### (Configuration of Multilayer Ceramic Capacitor)

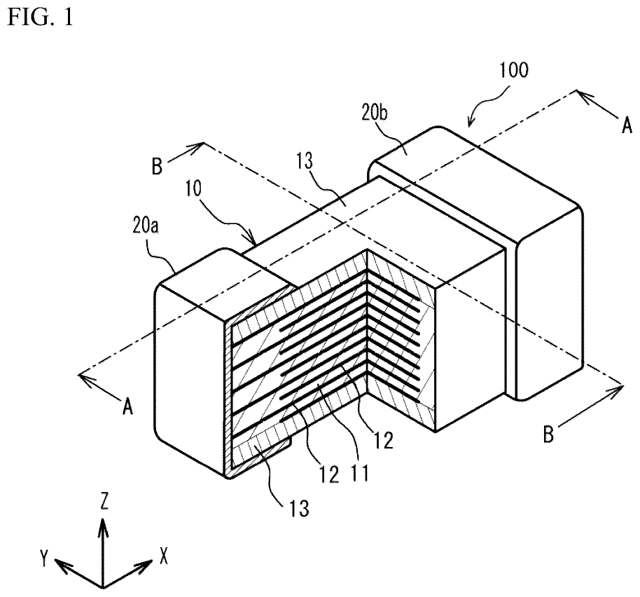

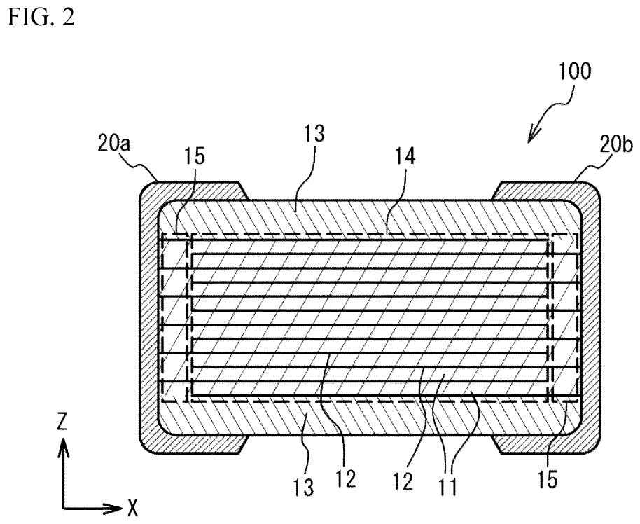

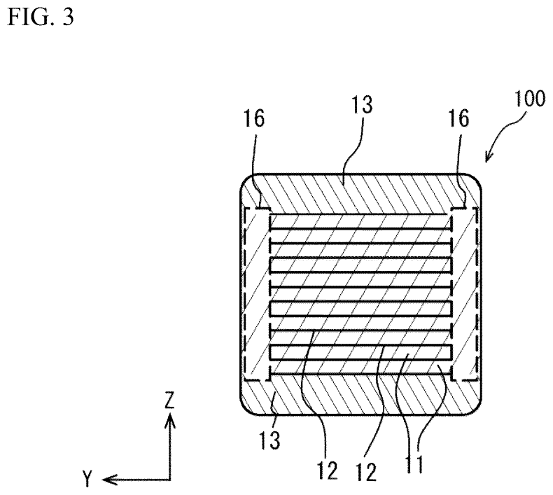

FIG. 1 is a partial perspective view of a multilayer ceramic capacitor 100 according to an embodiment of the present invention. FIG. 2 is a sectional view taken along line A-A in FIG. 1. FIG. 3 is a sectional view taken along the line B-B in FIG. 1. As illustrated in FIGS. 1 to 3, the multilayer ceramic capacitor 100 includes an element body 10 having a substantially rectangular parallelepiped shape and external electrodes 20a and 20b provided on two opposing end surfaces of the element body 10. Of the four surfaces of the element body 10 other than the two end surfaces, two surfaces other than the upper surface and the lower surface in the lamination direction are referred to as side surfaces. The external electrodes 20a and 20b extend to the upper surface, the lower surface and two side surfaces of the element body 10 in the lamination direction. However, the external electrodes 20a and 20b are spaced apart from each other.

Also, in FIGS. 1 to 3, the Z-axis direction (first direction) is a lamination direction, and is a direction in which the internal electrode layers face each other. The X-axis direction (second direction) is the length direction of the element body 10, in which the two end faces of the element body 10 face each other, and in which the external electrode 20a and the external electrode 20b face each other. The Y-axis direction (third direction) is the width direction of the element body 10, and is a direction in which the two side surfaces of the four side surfaces of the element body 10 other than the two end surfaces face each other. The X-axis direction, the Y-axis direction, and the Z-axis direction are perpendicular to each other.

The element body 10 has a structure wherein dielectric layers 11 containing a ceramic material functioning as a dielectric and internal electrode layers 12 are alternately laminated. The edge of each internal electrode layer 12 is alternately exposed to the end face of the element body 10 on which the external electrode 20a is provided and the end face on which the external electrode 20b is provided. Thus, the internal electrode layers 12 are alternately electrically connected to the external electrodes 20a and 20b. As a result, the multilayer ceramic capacitor 100 has a structure in which a plurality of dielectric layers 11 are laminated between the internal electrode layers 12. In the multilayer body of the dielectric layers 11 and the internal electrode layers 12, the internal electrode layer 12 is disposed on the outermost layer in the lamination direction, and the upper and lower surfaces of the multilayer body are respectively covered with cover layers 13. The cover layer 13 is mainly composed of a ceramic material. For example, the cover layer 13 may have the same composition as or different composition from the dielectric layer 11. The configuration is not limited to the configuration illustrated in FIGS. 1 to 3 as long as the internal electrode layer 12 is exposed on two different surfaces and is electrically connected to different external electrodes.

The size of the multilayer ceramic capacitor 100 is, for example, a length of 0.25 m, a width of 0.125 mm, and a height of 0.125 mm, or a length of 0.4 mm, a width of 0.2 mm, and a height of 0.2 mm, or a length of 0.6 mm, a width of 0.3 mm, and a height of 0.3 mm, or a length of 1.0 mm, a width of 0.5 mm, and a height of 0.5 mm, or a length of 3.2 mm, a width of 1.6 mm, and a height of 1.6 mm, or a length of 4.5 mm, a width of 3.2 mm, and a height of 2.5 mm, but is not limited to these sizes.

The internal electrode layer 12 is mainly composed of a base metal such as nickel (Ni), copper (Cu), or tin (Sn), or an alloy containing these metals. The inner internal electrode layer 12 may be made of a noble metal such as platinum (Pt), palladium (Pd), silver (Ag), or gold (Au), or an alloy containing these metals. The average thickness per layer of the internal electrode layer 12 in the Z-axis direction is, for example, 0.3 μm or more and 8.0 μm or less, 0.4 μm or more and 7.0 μm or less, and or 0.5 μm or more and 6.0 μm or less. The thickness of the internal electrode layer 12 can be measured by observing the cross section of the multilayer ceramic capacitor 100 with a scanning electron microscope (SEM), measuring the thickness of each of ten different internal electrode layers 12 at ten points, and deriving the average value of all the measurement points.

The dielectric layer 11 has, for example, a ceramic material having a perovskite structure represented by a general formula ABO₃ as a main phase. The perovskite structure contains ABO_{3-α} that is not in the stoichiometric composition. In the present embodiment, barium titanate (BaTiO₃) is used as a main component ceramic of the dielectric layer 11. The dielectric layer 11 contains barium titanate in an amount of, for example, 90 at % or more.

As illustrated in FIG. 2, the section where the internal electrode layer 12 connected to the external electrode 20a and the internal electrode layer 12 connected to the external electrode 20b face each other is a section where an electric capacitance is generated in the multilayer ceramic capacitor 100. Therefore, the section where the electric capacitance is generated is referred to as a capacitance section 14. That is, the capacitance section 14 is a section where adjacent internal electrode layers 12 connected to the different external electrodes 20a and 20b face each other.

A section where the internal electrode layers 12 connected to the external electrode 20a face each other without the internal electrode layers 12 connected to the external electrode 20b therebetween is referred to as an end margin 15. The end margin 15 also includes a section where the internal electrode layers 12 connected to the external electrode 20b face each other without the internal electrode layers 12 connected to the external electrode 20a therebetween. That is, the end margin 15 is a section where the internal electrode layers 12 connected to the same external electrode face each other without interposing the internal electrode layers 12 connected to different external electrodes. The end margin 15 is a section where no electric capacitance is generated.

As illustrated in FIG. 3, in the element body 10, a side margin 16 is a section provided so as to cover the ends (ends in the Y axis direction) on the two side surfaces of the dielectric layer 11 and the internal electrode layer 12. That is, the side margin 16 is a section provided outside the capacitance section 14 in the Y-axis direction. The side margin 16 is also a section where no electric capacitance is generated.

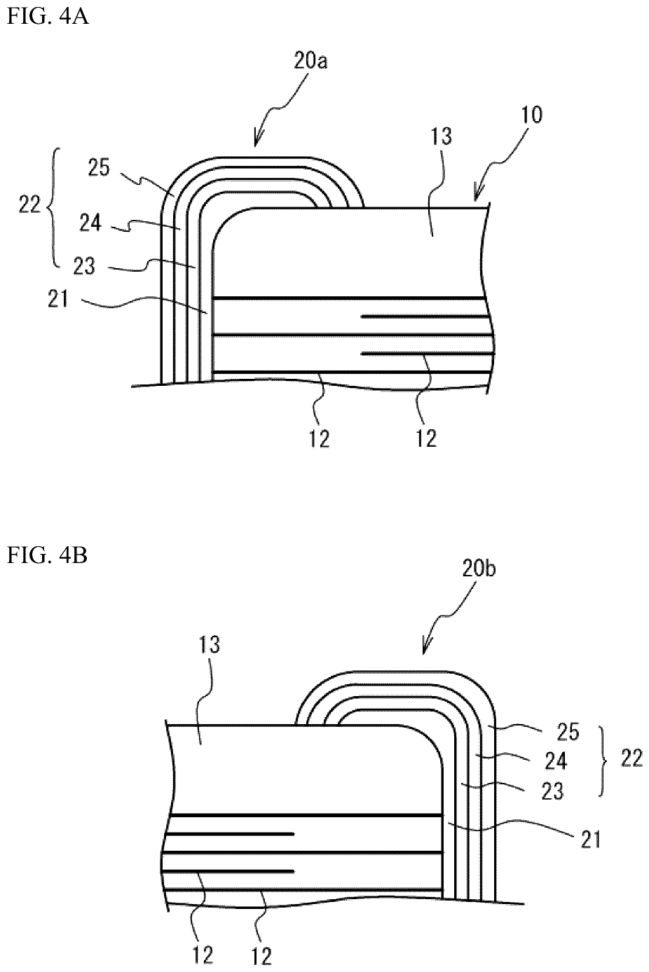

FIG. 4A is an enlarged sectional view of the vicinity of one external electrode 20a. FIG. 4B is an enlarged sectional view of the vicinity of the other external electrode 20b. In FIGS. 4A and 4B, the hatch for representing the cross section is omitted. As illustrated in FIGS. 4A and 4B, the external electrodes 20a and 20b have a structure in which a plating layer 22 is provided on a base layer 21. The base layer 21 is mainly composed of nickel, copper, or the like. The base layer 21 may contain ceramic particles or glass components as the co-material. The plating layer 22 is mainly composed of a metal such as nickel, copper, aluminum, zinc, or tin, or an alloy of two or more of these metals. The plating layer 22 may be a plating layer of a single metal component or a plurality of plating layers of different metal components. For example, the plating layer 22 has a structure in which a first plating layer 23, a second plating layer 24, and a third plating layer 25 are formed in this order from the base layer 21 side. The first plating layer 23 is, for example, a copper plating layer. The second plating layer 24 is, for example, a nickel plating layer. The third plating layer 25 is, for example, a tin plating layer.

### (Configuration of Dielectric Layer)

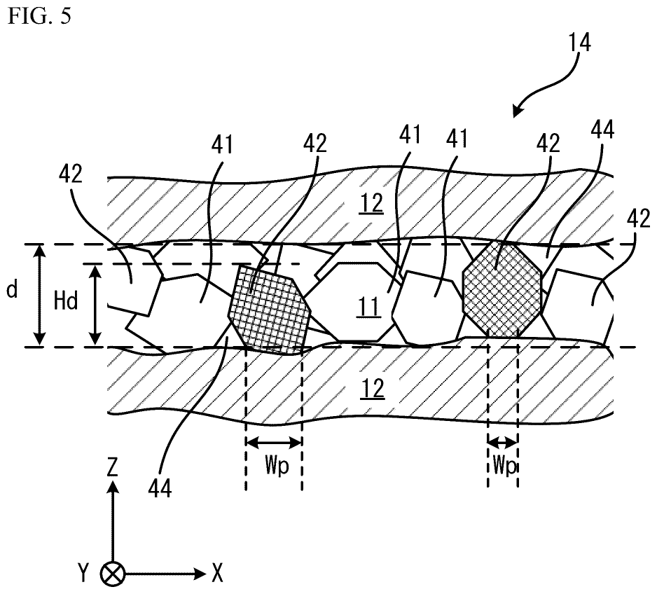

FIG. 5 is an enlarged sectional view of a part of the dielectric layer 11. The cross section is a cross section of the capacitance section 14 along the lamination direction as illustrated in FIGS. 2 and 3.

The dielectric layer 11 includes first crystal grains 41 of a main component ceramic having a perovskite structure represented by a general formula ABO₃ and second crystal grains 42 whose main component is a barium titanate complex oxide in which an elemental ratio of barium to titanium of 0.70 or less. The dielectric layer 11 has a structure in which a plurality of first crystal grains 41 constituting a main phase and one or more second crystal grains 42 are sintered. For example, the dielectric layer 11 may have one first crystal grain 41 in the thickness direction, or may have a structure in which a plurality of first crystal grains 41 are continuous through grain boundaries as illustrated in FIG. 5. Also, the second crystal grains 42 fill gaps 44 between the first crystal grains 41.

The first crystal grains 41 are, for example, barium titanate. Therefore, the dielectric layer 11 shows a favorable electrostatic capacitance compared with other ceramic materials. The first crystal grains 41 may be barium titanate in which another element is dissolved.

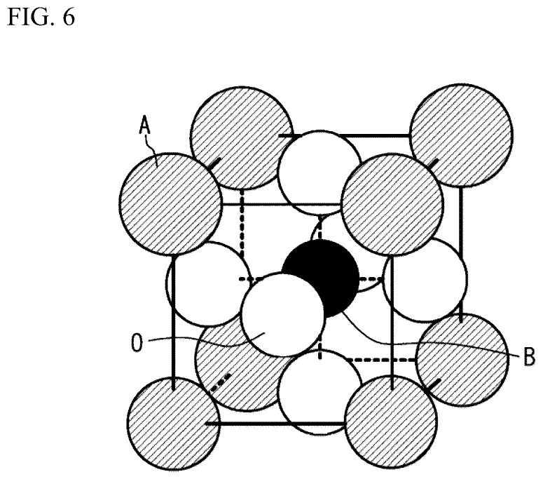

FIG. 6 is a view illustrating an example of a unit lattice of the perovskite structure of the first crystal grain 41. The first crystal grains 41 are crystal particles of barium titanate (BaTiO₃) having a perovskite structure. The crystal particles having the perovskite structure have a unit lattice as illustrated in FIG. 6. In this unit lattice, there are an A-site located at the apex of the lattice, an O-site located at the face center of the lattice, and a B-site located within an octahedron with the O-site as the apex. In the perovskite structure, an alkaline earth metal that can take divalent cations such as barium (Ba), strontium (Sr), and calcium (Ca) are located at the A-site, and a metal atom that can take tetravalent cations such as hafnium (Hf), zirconium (Zr), and titanium (Ti) are located at the B-site. In the present embodiment, barium may be located at the A-site and titanium may be located at the B-site, and at least one of the A-site and the B-site may be partially substituted by an additive element.

The perovskite structure also allows a composition formula that deviates from the stoichiometric composition. That is, the ratio of the A-site element to the B-site element does not necessarily have to be 1:1, and defects may be generated within a range where the perovskite structure can be maintained. Furthermore, defects may also be generated regarding oxygen. For example, when the composition formula is A_{α}BO_{3-β}, compositions in the ranges of 0.98≤α≤1.01 and 0≤β≤0.20 are allowed.

However, due to the generation of oxygen defects, for example, the resistivity decreases and ionic conductivity is exhibited, which reduces the electrical life when used as a multilayer ceramic capacitor and increases the dielectric loss, which in turns make it not practical for use. Therefore, if necessary, at least one of the first transition elements: scandium (Sc), titanium (Ti), vanadium (V), chromium (Cr), iron (Fe), cobalt (Co), nickel (Ni), copper (Cu), zinc (Zn) may be added to the first crystal grains 41 having a perovskite structure. This makes it possible to improve resistivity, extend electrical life, and reduce dielectric loss of capacitance.

In addition, the first crystal grains (which may be referred to as particles) 41 may include at least one of the second transition elements such as yttrium (Y), zirconium (Zr), niobium (Nb), molybdenum (Mo), ruthenium (Ru), rhodium (Rh), palladium (Pd) and silver (Ag). This makes it possible to improve resistivity, extend electrical life, and reduce dielectric loss of capacitance.

In addition, the first crystal grains 41 may include at least one of the third transition elements such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), lutetium (Lu), hafnium (Hf), tantalum (Ta), tungsten (W), rhenium (Re), osmium (Os), iridium (Ir), platinum (Pt), and gold (Au). This makes it possible to improve resistivity, extend electrical life, and reduce dielectric loss of capacitance.

The second crystal grains 42 are produced when an additive containing titanium as a main component (for example, titanium oxide) is used for barium titanate, and are barium titanate complex oxides having an elemental ratio (ratio of the number of elements) of barium to titanium of 0.70 or less. Examples of the second crystal grains 42 include BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, and Ba₆Ti₁₇O₄₀.

The second crystal grains 42 are preferably a barium titanate complex oxide such as Ba₄Ti₁₁O₂₆ among these examples, which is monoclinic and has a space group C2/m, and has lattice constants a=15.160 Å, b=3.893 Å, and c=9.093 Å with β=98.6°. This is because this barium titanate complex oxide has a ratio of barium to titanium that is relatively close to 1, and can be easily precipitated intentionally without using a large amount of additives having its main component as titanium. This barium titanate complex oxide is described, for example, in the non-patent literature Acta Cryst. (1979). B35, 1590-1593.

As a more preferable example of the second crystal grains 42, it is desirable that manganese is solid-dissolved in Ba₄Ti₁₁O₂₆ to occupy the defect sites thereof, or replace some titanium. As is clear from the above-mentioned non-patent literature, Ba₄Ti₁₁O₂₆ has a crystal structure in which some titanium sites have defects. Therefore, titanium tends to change from a tetravalent cation to a trivalent cation at the defect location, and as a result, the resistivity tends to decrease. In order to supplement this, it is effective to include manganese in solid solution.

The second crystal grains 42 are formed so as to fill the gaps 44 generated in the firing step during the manufacture of the multilayer ceramic capacitor 100. The second crystal grains 42 are in contact with at least one of the pair of internal electrode layers 12 sandwiching one of the dielectric layers 11.

Therefore, the second crystal grains 42 can sufficiently reduce the gap 44 in the dielectric layer 11 in a state of being connected to at least the one of the pair of the internal electrode layers 12. This strengthens the element body 10 and improves the resistance of the dielectric layer 11 to electrostriction and the like. Therefore, the overall mechanical strength of the multilayer ceramic capacitor 100 is improved. In the case where the second crystal grains 42 are in contact with both of the pair of the internal electrode layers 12, the second crystal grains 42 function as columnar members connecting the two internal electrode layers 12, and therefore, the mechanical strength of the element body 10 can be further improved. Since the second crystal grains 42 contain more additive elements (Si, AL, Ca, Mn, Mg, Ho, Dy, etc.) than the first crystal grains 41, the second crystal grains 42 have a lower hardness than the first crystal grains 41, and therefore, even if stress acts on the dielectric layer 11, the occurrence of cracks can be effectively inhibited. In addition, the hardness of the first crystal grains 41 and the second crystal grains 42 can be measured by, for example, a nanoindenter.

Further, the second crystal grains 42 can sufficiently reduce the gaps 44 in the dielectric layer 11, so that the resistance value of the dielectric layer 11 increases, and the insulation resistance between the internal electrode layers 12 can be increased. Also, since the second crystal grains 42 are bonded to the first crystal grains 41 around the second crystal grains 42, the movement of the first crystal grains 41 during the firing is suppressed, and variation in the thickness of the dielectric layer 11 is reduced. This reduces variations in the electric field strength when a voltage is applied between the internal electrode layers 12. Therefore, the reliability of the multilayer ceramic capacitor 100 is improved.

Here, it is preferable that the second crystal grains 42 have a size Hd of 80% or more of the thickness d of the cross section of the dielectric layer 11 along the lamination direction (Hd/d 80). According to this configuration, since the gap 44 of the dielectric layer 11 can be suitably filled with the second crystal grains 42, the strength of the element body 10 is further enhanced, and the resistance and insulation of the dielectric layer 11 are further improved.

In addition, in the direction substantially perpendicular to the lamination direction (in the X direction in this example), the width Wp of the contact region of the second crystal grains 42 with respect to the internal electrode layer 12 is preferably, for example, 50 to 500 μm. The width Wp can further suitably improve the resistance of the dielectric layer 11 to electrostriction and the like.

The lower limit of the width Wp is determined, for example, from the viewpoint of sufficiently relaxing the stress acting on the dielectric layer. The lower limit of the width Wp is not limited to 50 μm, but is preferably 40 μm, and more preferably 30 μm.

The upper limit of the width Wp is determined, for example, from the viewpoint of sufficiently relaxing the stress acting on the dielectric layer. The upper limit of the width Wp is not limited to 500 μm, but is preferably 400 μm, and more preferably 300 μm.

In the present embodiment, the width Wp in the longitudinal direction of the multilayer ceramic capacitor 100 is exemplified, but the width Wp is not limited to a width in the longitudinal direction, and may be a width in a direction orthogonal to the lamination direction. That is, the width Wp is a dimension of the contact region of the second crystal grains 42 with respect to the internal electrode layer 12 in an arbitrary direction. The measurement of the width Wp is realized by, for example, the following method. The width Wp can be measured by observing the cross section of the multilayer ceramic capacitor 100 with a scanning electron microscope (SEM), setting a reference line passing through the point where the thickness of the internal electrode layer 12 in the lamination direction is maximum along the length direction or the width direction of the multilayer ceramic capacitor 100 using image analysis software or the like, and deriving the length of contact between the reference line and the second crystal grains 42.

The effect described above becomes more remarkable as the dielectric layer 11 becomes thinner. From this viewpoint, for example, the thickness d of the cross section of the dielectric layer 11 is preferably 0.4 μm or less. The upper limit of the thickness d is not limited to 0.4 μm, but is preferably 0.3 μm, and more preferably 0.2 μm.

In addition, from the viewpoint of sufficiently relaxing the stress acting on the dielectric layer, for example, the thickness d of the cross section of the dielectric layer 11 is preferably 0.3 μm or more. The lower limit of the thickness d is not limited to 0.3 μm, but is preferably 0.4 μm, and more preferably 0.5 μm.

The thickness of the dielectric layer 11 can be measured by observing the cross section of the multilayer ceramic capacitor 100 with a SEM (Scanning Electron Microscope), measuring the thickness of each of ten different dielectric layers 11 at ten points, and deriving the average value of all the measurement points.

In addition, the size Hd of the second crystal grains 42 along the lamination direction is measured by, for example, the following method. The size Hd can be measured by observing a cross section of the multilayer ceramic capacitor 100 with a SEM (Scanning Electron Microscope) and detecting the second crystal grains 42 by using image analysis software or the like.

Also, the ratio of the contents of the first crystal grains 41 and the second crystal grains 42 in the dielectric layer 11 is as follows. For example, when the ratio of the area occupied by the first crystal grains 41 to the area of the cross section along the lamination direction as illustrated in FIGS. 2 and 3 is S1 and the ratio of the area occupied by the second crystal grains 42 to the area of the cross section along the lamination direction as illustrated in FIGS. 2 and 3 is S2, S1 is about 90% or more and 95% or less, and S2 is about 3% or more and 20% or less.

Here, the fact that the dielectric layer 11 contains the second crystal grains 42 can be confirmed by the following procedure. Also, the presence or absence of contact between the second crystal grains 42 and the internal electrode layer 12 can be confirmed in the same manner as the above-described method for confirming the width Wp.

First, the diffraction line profile of the surface of the dielectric layer 11 to be evaluated or the powder obtained by crushing the dielectric layer 11 to be evaluated is measured using an X-ray diffractometer (XRD) using Cu-Kα rays. The pulverizing method for obtaining the powder is not particularly limited, and a hand mill (mortar/pestle) or the like can be used. In addition, when measuring the diffraction profile of the ceramics that make up the multilayer ceramic capacitor 100, it is necessary to remove the electrodes and coatings formed on the surface of the component, as well as parts other than the dielectric layers 11 of the multilayer ceramic capacitor 100, thereby exposing the surface of the dielectric layers 11. This exposure method is not particularly limited, and any method of cutting or polishing the component can be adopted. In addition, when measuring the diffraction profile of the powder of the dielectric layers 11 that makes up the multilayer ceramic capacitor 100, the external electrodes 20a, 20b and coatings formed on the component, as well as parts other than the dielectric layer 11 of the multilayer ceramic capacitor 100, are preferably removed before crushing it.

Next, in the obtained diffraction profile, the percentage of the strongest diffraction line intensity derived from other structures with respect to the strongest diffraction line intensity derived from the perovskite structure is calculated. If this ratio is 10% or less, it is determined that the dielectric layer 11 to be evaluated is composed of a main phase having a perovskite structure. In addition, when the surface of the dielectric layer 11 of the multilayer ceramic capacitor 100 is exposed using the above method, or when XRD measurement is performed on pulverized powder, peaks of the materials constituting the external electrodes 20a, 20b and coatings may also be detected. Therefore, the above-mentioned ratio of diffraction line intensity is calculated after excluding these.

Next, the crystal phase is evaluated by focusing on peaks other than the diffraction line intensities derived from the perovskite structure. In doing so, it is preferable to refer to the PDF (Powder Diffraction File) published by ICDD (International Centre for Diffraction Data; Pennsylvania, USA) in order to search and identify the second crystal grains 42. In case of Ba₄Ti₁₁O₂₆ as a preferred example, its production can be evaluated by identifying it with reference to PDF-01-083-1459.

Next, using the following method, whether or not the second crystal grains 42 are made of a barium titanate complex oxide in which the elemental ratio of barium to titanium is 0.70 or less is determined.

First, the surface of the dielectric ceramic composition is exposed. This exposure method is not particularly limited, and any method of cutting or polishing the device can be adopted. At this time, in order to fully observe the internal ceramic structure, it is preferable to obtain a smoothness that can be judged as a mirror surface by using a diamond paste of 2 μm or less or the like.

Next, an energy dispersive X-ray spectrometer (EDS) or a wavelength dispersive X-ray spectrometer (WDS), which is attached to a scanning electron microscope (SEM) or transmission electron microscope (TEM), or an electron probe microanalyzer (EPMA), or a laser irradiation inductively coupled plasma mass spectrometry (LA-ICP-MS) or the like is used to analyze the composition of the second crystal grains 42.

For example, in EDS measurement, simply, the K-line intensity of titanium relative to the K-line or L-line of barium or the K-line of manganese can be used to analyze the composition. More specifically, from these intensities, a correction (ZAF correction) is performed that takes into account the atomic number effect, absorption effect, and fluorescence excitation effect, and the ratio of each to the elemental content of titanium is calculated, and the ratio of each element is calculated.

When performing EDS measurements, especially when using barium's La ray and titanium's Kα ray, their energy peaks are close to each other, and it may be difficult to adequately compare the element contents. For this reason, it is desirable that the Lβ2 line and LIIIab line of barium, which do not have peak overlap, be obtained with sufficient intensity for the measurement. Specifically, it is preferable that the intensity at the peak is 10,000 counts or more. This way, the intensity of the characteristic X-rays from barium can be determined and the element content can be calculated, so even if the Lα line of barium and the Kα line of Ti overlap, the intensity of the Kα rays of titanium can be determined, and the element content can be evaluated with high accuracy.

When the elemental ratio of barium to titanium obtained by the above method is 0.70 or less, the evaluated crystal grain is determined to be the second crystal grain 42. That is, it is determined that it is one of the above-mentioned barium titanate complex oxides based on the fact that the elemental ratio of barium to titanium is small compared to barium titanate existing in the surroundings. Here, when an SEM is used for observation, the second crystal grains 42 have a relatively low brightness (i.e., darker image) compared to the barium titanate in the observation using a back scattered electron image (BSE image). Moreover, as an even more preferable evaluation method, the second crystal grains 42 may be evaluated by using the diffraction profile by XRD. In more detail, the part determined to be the second crystal grain 42 is cut out as a sample for transmission electron microscopy (TEM) observation, and a diffraction image obtained using a selected area diffraction method is obtained. By comparing with data from literature, it can be confirmed whether it can be determined as one of BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, and Ba₆Ti₁₇O₄₀. Note that this cutout can be performed using an FIB device or the like.

### (Method of Manufacturing Multilayer Ceramic Capacitor)

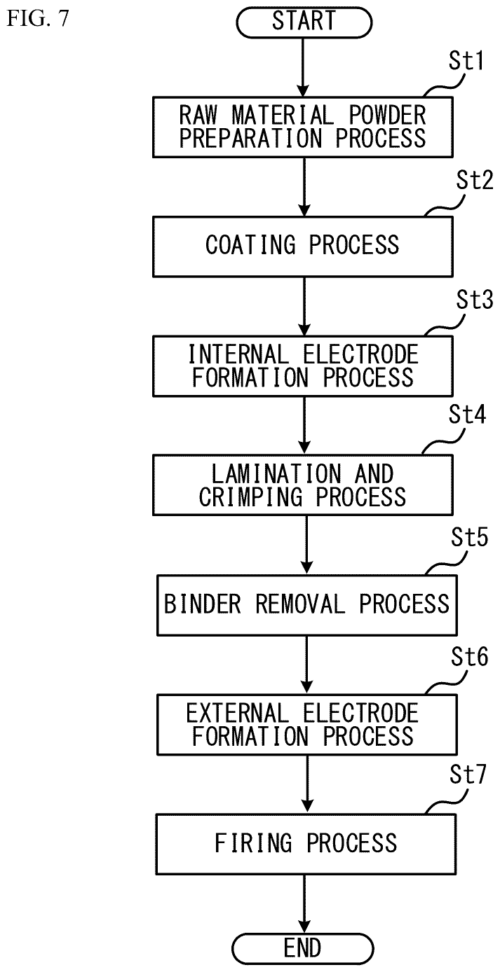

FIG. 7 is a flowchart illustrating a method of manufacturing the multilayer ceramic capacitor 100.

### (Raw Material Powder Preparation Process St1)

First, a dielectric ceramic composition for forming the dielectric layers 11 is prepared. The A-site element and the B-site element contained in the dielectric layer 11 are usually contained in the dielectric layer 11 in the form of a sintered body of ABO₃ particles. For example, barium titanate is a compound that has a perovskite structure and belongs to the tetragonal system near room temperature, and exhibits a high dielectric constant. This barium titanate can generally be synthesized by reacting a titanium raw material such as titanium dioxide with a barium raw material such as barium carbonate. Various methods are conventionally known for synthesizing barium titanate, which is the main component of the dielectric layer 11, such as a solid phase method, a sol-gel method, and a hydrothermal method. In this embodiment, any of these can be adopted.

Titanium is added to the barium titanate powder obtained as described above. For example, titanium oxide (TiO2) or the like can be added. In the present embodiment, it is preferable to add titanium to the barium titanate powder so that the elemental ratio of barium to titanium is 0.900 to 0.995. For example, an amount of 0.5 mol to 10 mol of titanium is added to 100 mol of barium titanate powder.

Prescribed additives are added to the obtained ceramic powder. As an example, an oxide or glass containing Zr (zirconium), V (vanadium), Cr (chromium), Co (cobalt), Ni (nickel), Li (lithium), B (boron), Na (sodium), and K (potassium) may be used. Further, if necessary, oxides of Gd (Gadolinium), Sc (Scandium), Y (Yttrium), La (Lanthanum), Ce (Cerium), Pr (Praseodymium), Nd (Neodymium), Pm (promethium), Sm (Samarium), Tb (Terbium), Dy (Dysprosium), Ho (Holmium), Er (Erbium), Tm (Thulium), Y (Ytterbium) and Lu (Lutetium) may be added as rare earth elements.

For example, a compound containing an additive compound may be wet-mixed with barium titanate powder, dried and pulverized to prepare a ceramic material in which barium titanate powder and the additive compound are mixed. For example, if necessary, the ceramic material obtained as described above may be pulverized to adjust the particle diameter, or may be combined with a classification process to adjust the particle diameter. Specifically, along with the ceramic material, beads with a diameter of 0.1 mm to 3 mm made of yttrium-stabilized zirconia, alumina, or silicon nitride may be stirred for 10 to 100 hours in order to adjust the particle diameter. Through the above steps, a dielectric ceramic composition is obtained.

### (Coating Process St2)

Next, a binder such as polyvinyl butyral (PVB) resin, an organic solvent such as ethanol or toluene, and a plasticizer are added to the obtained dielectric ceramic composition and wet-mixed. Using the obtained slurry, a ceramic green sheet 51 is coated on a base material by, for example, a die coater method or a doctor blade method, and then dried. The base material is, for example, a polyethylene terephthalate (PET) film. Figures illustrating the coating process are omitted.

### (Internal Electrode Formation Process St3)

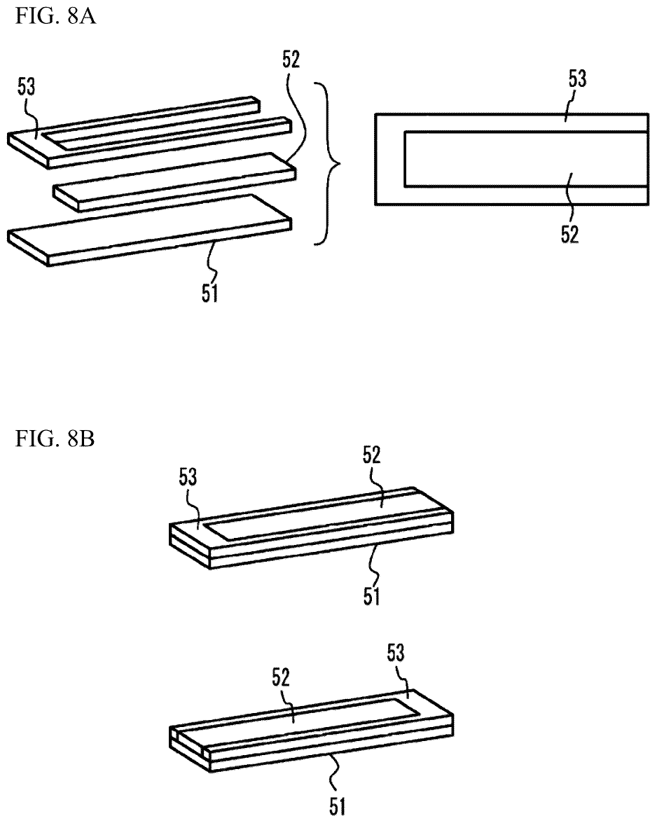

FIGS. 8A and 8B are views illustrating the internal electrode forming process St3. After the coating process St2, a metal conductive paste containing an organic binder for forming internal electrodes is printed on the surface of the ceramic green sheet 51 by screen printing, gravure printing, etc., to form internal electrode patterns 52 that are to be arranged alternately to a pair of external electrodes. Ceramic particles are added to the metal conductive paste as a co-material. Although the main component of the ceramic particles is not particularly limited, it is preferably the same as the main component ceramic of the dielectric layer 11. For example, barium titanate having an average particle diameter of 50 nm or less may be uniformly dispersed.

Next, a binder such as ethyl cellulose and an organic solvent such as terpineol are added to the dielectric ceramic composition obtained in the raw material powder manufacturing process, and the mixture is kneaded in a roll mill to form a dielectric pattern paste for the reverse pattern layer. As illustrated in FIG. 8A, on the ceramic green sheet 51, a dielectric pattern 53 is arranged by printing the dielectric pattern paste in the peripheral area where the internal electrode pattern 52 is not printed, thereby filling in a step with respect to the internal electrode pattern 52. The ceramic green sheet 51 on which the internal electrode pattern 52 and the dielectric pattern 53 are printed is referred to as a lamination unit.

Thereafter, as illustrated in FIG. 8B, the lamination unites are stacked such that the internal electrode layers 12 and the dielectric layers 11 are arranged alternately, and that the edges of the internal electrode layers 12 are alternately exposed and drawn out alternately to a pair of external electrodes 20a and 20b having different polarities. For example, the number of stacked layers of the internal electrode pattern 52 is set to 100 to 1000 layers.

### (Lamination and Crimping Process St4)

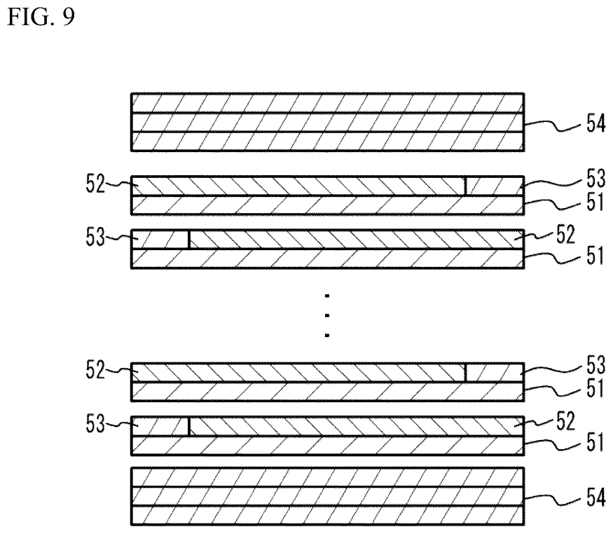

FIG. 9 is a view illustrating the lamination and crimping process St4. A predetermined number (for example, 2 to 10 layers) of cover sheets 54 are laminated on top and bottom of the laminate, in which the lamination units have been laminated, and are bonded by thermocompression. As an example of the ceramic material for the cover sheet 54, the dielectric ceramic composition described above can be used. Thereafter, it is cut into a predetermined chip size (for example, 1.0 mm×0.5 mm). Here, side margin portions may be attached or coated on the side surfaces of the laminate instead.

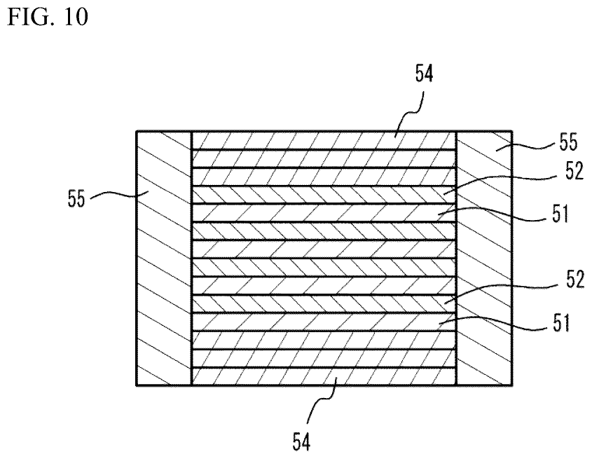

FIG. 10 is a diagram illustrating the side margin portion 55. A laminated body may be obtained by alternately laminating the ceramic green sheets 51 and the internal electrode patterns 52 that have the same width as the ceramic green sheets 51. Then, sheets formed of dielectric pattern paste may be attached as the side margin portions 55 to the side surfaces of the laminated body, respectively.

### (Binder Removal Process St5)

Next, the binder removal process St5 is performed. In the binder removal process St5, the above-mentioned laminated body is processed by the binder removal process in an N2 atmosphere at 250 to 500° C. The binder removal process produces a liquid phase component including glass or the like in the dielectric pattern 53. After the binder removal process, the liquid phase component becomes solid by cooling the laminated body, but becomes liquid phase again by heating in the subsequent sintering firing process St7.

### (External Electrode Formation Process St6)

Next, an external electrode formation process St6 is performed. In the external electrode formation process St6, a metal paste containing, for example, a metal powder, a glass frit, a binder, and a solvent is applied to each end face, the upper face, the lower face, and each side face of the laminate by a dip method. After the application of the metal paste, the metal paste is baked through the following firing process St7.

### (Firing Process St7)

The firing step St7 is performed, for example, in two stages of a first step and a second step. In the first step, the laminated body is fired, for example, at 1000° C. for 15 to 60 minutes in an atmosphere having a hydrogen concentration of 0.05 to 1.0%. In the first step, necking of the first crystal grains 41 which become the main phase of the dielectric layer 11 are performed. As described later, the liquid phase component generated during the binder removal process St5 moves into the gap 44 between the bonded first crystal grains 41. The liquid phase component contains the second crystal grains 42, as a main component, formed from titanium of an additive. Also, the temperature rising rate until reaching 1000° C. is, for example, 1000° C./h. This makes it possible to appropriately control the size Hd of the second crystal grains 42 with respect to the thickness d of the dielectric layer 11.

Next, in the second step, the ceramic laminated body is fired in a reducing atmosphere of an oxygen partial pressure of 10-12 to 10-9 atm at 1200° C. to 1300° C. for 2 to 6 hours. In the second step, the second crystal grains 42 are deposited from the liquid phase component existing in the gaps 44 between the first crystal grains 41, and the gaps 44 are filled with the second crystal grains 42. As a result, the dielectric layer 11 is made denser by the phase of the precipitated second crystal grains 42. In this way, the multilayer ceramic capacitor 100 is obtained. Thereafter, formation process of the plating layers 22 to 25 of the external electrodes 20a and 20b (plating process step) and a reoxidation process may be performed.

### (Formation of Dielectric Layers)

Next, the process of forming the dielectric layers 11 in the above-described firing process St7 will be described.

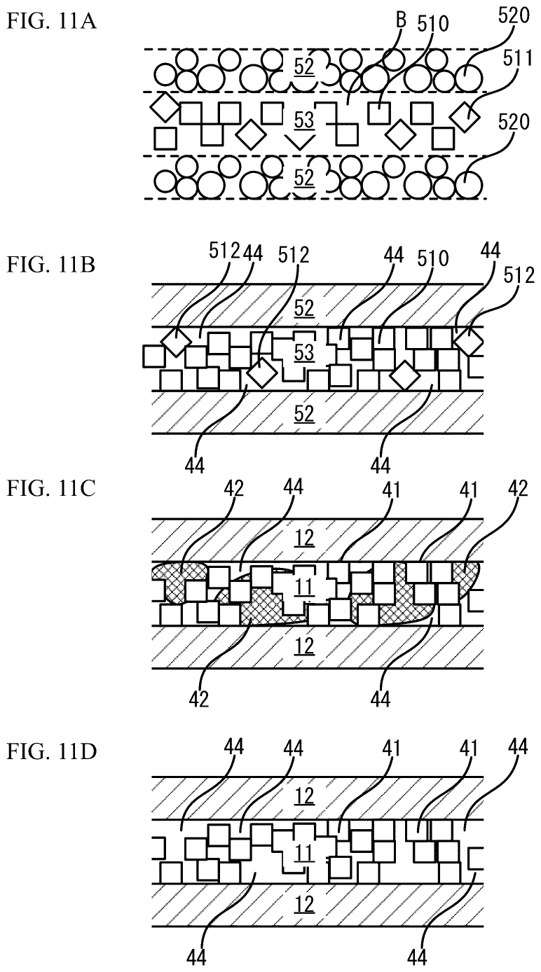

FIG. 11A is a sectional view illustrating the internal electrode pattern 52 and the dielectric pattern 53 before the firing process St7. The internal electrode pattern 52 includes, for example, a large number of nickel particles 520. Also, the dielectric pattern 53 includes a ceramic main component 510 containing, for example, barium titanate, a liquid phase component 511 generated by the binder removal process St5, and a void B also generated by the binder removal process St5. The liquid phase component 511 contains the second crystal grains 42 as a main component, and SiO₂, aluminum, and the like are also contained.

FIG. 11B is a sectional view illustrating the internal electrode pattern 52 and the dielectric pattern 53 after the first step of the firing step St7. In the first step, the firing is performed at 1000° C. for 15 to 60 minutes. As a result, the organic substance in the metal paste is volatilized, and the nickel particles 520 in the internal electrode pattern 52 are bonded to each other to form metallic nickel. Further, necking of the first crystal grains 41 in the dielectric pattern 53 are performed to form the new gap 44 between the first crystal grains 41. A liquid phase component 512 containing the second crystal grains 42 as the main component moves into the gap 44. The liquid phase component 512 is the liquid phase component 511 that has been transformed through the first step and exists as a glass containing, for example, titanium at a ratio of 70%. When the firing temperature exceeds the softening point of the glass, the liquid phase component 512 softens and moves into the gaps 44. Also, the liquid phase component 512 contains titanium, rare earth, and the like in addition to the second crystal grains 42. The liquid phase component 512 penetrates the gaps 44 as the temperature rises, and aggregates and segregates through the grain boundaries.

FIG. 11C is a sectional view illustrating the dielectric layer 11 after the second step of the firing step St7. In the second step, the laminated body is fired at 1200 to 1300° C. for 2 to 6 hours in a reducing atmosphere of an oxygen partial pressure of 10-12 to 10-9 atm. At this time, the liquid phase component 512 remains in the gaps 44 between the first crystal grains 41, and the second crystal grains 42 are deposited from the liquid phase component 512 to fill the gaps 44. As a result, the dielectric layer 11 is made denser by the phase of the precipitated second crystal grains 42. This improves the strength of the dielectric layer 11, and hence good resistance to electrostriction can be obtained. The electric resistance of the dielectric layer 11 is also improved by filling the gaps 44 with the second crystal grains 42.

FIG. 11D is a cross-sectional view illustrating the dielectric layer 11 in which the second crystal grains 42 are absent. When a voltage is applied between the internal electrode layers 12, a large current flows through the low-resistance gap 44 as compared with the portion where the first crystal grains 41 exist. Therefore, the resistance of the dielectric layer 11 is lower than that in the case where the second crystal grains 42 are present.

### Working Examples

Next, an embodiment of the multilayer ceramic capacitor 100 will be described.

### Working Examples 1 to 4 and Comparative Example 1

Barium titanate powder having an average particle diameter of 150 nm was prepared, and with respect to 100 mol of barium titanate powder, 0.75 mol of Gd₂O₃, 0.5 mol of TiO₂, 1.5 mol of MnCO₃, and 1.0 mol of SiO₂ were added to obtain a dielectric ceramic composition. The Ba/Ti element ratio was set to 0.995.

A dielectric slurry was prepared by mixing the dielectric ceramic composition with ethanol, toluene, and PVB (polyvinyl butyral) resin. This slurry was formed into a ceramic green sheet using a die coater. After drying this ceramic green sheet, nickel paste was printed to form an internal electrode pattern. The obtained lamination units were laminated, and thick layers of ceramic green sheets on which no internal electrode pattern was formed were crimped on top and bottom of the laminate, and then cut into small pieces. Thereafter, Ni paste was applied on the two end faces as a metal paste for external electrodes by dipping, and the binder removal process was performed in a nitrogen gas atmosphere. The processed piece was fired and sintered in a reducing atmosphere controlled to have an oxygen partial pressure that would not oxidize nickel.

The firing process was performed in two steps of the first and second steps described above. In the first step, the firing temperature was raised to 1000° C., and in the second step, the firing temperature was raised from 1000° C. to 1300° C. The firing temperature was maintained at 1000° C. for a predetermined time in each of Working Examples 1 to 4 and Comparative Example 1. This time is expressed as “1000° C. keeping time”.

The 1000° C. keeping time of Comparative Example 1 was set to 0 minute. The 1000° C. keeping time in Working Example 1 was set to 15 minutes. The 1000° C. keeping time in Working Example 2 was set to 30 minutes. The 1000° C. keeping time in Working Example 3 was set to 45 minutes. The 1000° C. keeping time in Working Example 4 was set to 60 minutes.

### Comparative Examples 2 to 8

A dielectric slurry was prepared by mixing barium titanate powder having an average particle diameter of 150 nm with ethanol, toluene, and PVB (polyvinyl butyral) resin. Unlike the Working Examples 1 to 4 and the Comparative Example 1, no additive compound was added to the barium titanate powder. The multilayer ceramic capacitor 100 was manufactured from this slurry by the same method as in Working Examples 1 to 4 and Comparative Example 1.

In the firing process, the firing temperature was raised from 1000° C. to 1300° C. The 1000° C. keeping time of Comparative Example 2 was set to 0 minute. The 1000° C. keeping time of Comparative Example 3 was set to 15 minutes. The 1000° C. keeping time of Comparative Example 4 was set to 30 minutes. The 1000° C. keeping time of Comparative Example 5 was set to 45 minutes. The 1000° C. keeping time of Comparative Example 6 was set to 60 minutes.

### (Reliability Test)

In the reliability test of Working Examples 1 to 4 and Comparative Examples 1 to 6, the HALT test was performed under the test conditions of 125° C.-15V to measure the life of the multilayer ceramic capacitor 100.

TABLE 1

| | PRESENCE OR | 1000° C. | LAYER | | |
|---|---|---|---|---|---|
| | ABSENCE OF | KEEPING | THICKNESS | | |
| | A COMPLEX | TIME | OCCUPANCY | LIFE | EVALU- |
| | OXIDE | (min) | (%) | (min) | ATION |
| COMPARATIVE | PRESENCE | 0 | 50 | 401 | X |
| EXAMPLE 1 | | | | | |
| WORKING | PRESENCE | 15 | 80 | 850 | ◯ |
| EXAMPLE 1 | | | | | |
| WORKING | PRESENCE | 30 | 90 | 862 | ◯ |
| EXAMPLE 2 | | | | | |
| WORKING | PRESENCE | 45 | 100 | 882 | ◯ |
| EXAMPLE 3 | | | | | |
| WORKING | PRESENCE | 60 | 100 | 885 | ◯ |
| EXAMPLE 4 | | | | | |
| COMPARATIVE | ABSENCE | 0 | 0 | 392 | X |
| EXAMPLE 2 | | | | | |
| COMPARATIVE | ABSENCE | 15 | 0 | 400 | X |
| EXAMPLE 3 | | | | | |
| COMPARATIVE | ABSENCE | 30 | 0 | 380 | X |
| EXAMPLE 4 | | | | | |
| COMPARATIVE | ABSENCE | 45 | 0 | 386 | X |
| EXAMPLE 5 | | | | | |
| COMPARATIVE | ABSENCE | 60 | 0 | 412 | X |
| EXAMPLE 6 | | | | | |

In Table 1, the “Presence or absence of a complex oxide” indicates whether or not the second crystal grains 42 are present in the dielectric layer 11 of the multilayer ceramic capacitor 100. The “1000° C. keeping time” indicates a keeping time of 1000° C. in the second step of the firing process as described above. The “Layer thickness occupancy” indicates the ratio (%) of the size Hd of the second crystal grain 42 to the thickness d of the dielectric layer 11 as illustrated in FIG. 4. The “Life” indicates the life of the multilayer ceramic capacitor 100. The “Evaluation” is indicated by “O” (OK) when the HALT test result is 750 minutes or more, and “X” (NG) when the HALT test result is less than 450 minutes.

The layer thickness occupancy was measured by cutting the multilayer ceramic capacitor 100 in the lamination direction and observing the cut surface with an electron microscope. The film thickness occupancy of Comparative Example 1 was 50%, that of Working Example 1 was 80%, that of Working Example 2 was 90%, and that of Working Examples 3 and 4 was 100%. Also, the film thickness occupancy of Comparative Examples 2 to 6 was 0%. As described above, the longer the 1000° C. keeping time is, the more the layer thickness occupancy increased.

The results of the HALT test are as follows. The life of Comparative Example 1 was 401 minutes, the life of Working Example 1 was 850 minutes, the life of Working Example 2 was 862 minutes, the life of Working Example 3 was 882 minutes, and the life of Working Example 4 was 885 minutes. Also, the life of Comparative Example 2 was 392 minutes, the life of Comparative Example 3 was 400 minutes, the life of Comparative Example 4 was 380 minutes, the life of Comparative Example 5 was 386 minutes, and the life of Comparative Example 6 was 412 minutes. As a result, the evaluation of Examples 1 to 4 was “O”, and the evaluation of Comparative Examples 1 to 6 was “X”.

As described above, the life of Working Examples 1 to 4 was longer than that of Comparative Examples 1 to 6. This is because the layer thickness occupancy ratio of Working Examples 1 to 4 is 80% or more, and thus the resistance and insulation of the dielectric layer 11 are improved as described above. On the other hand, since the layer thickness occupancy ratio of Comparative Example 1 was 50%, the gaps 44 of the dielectric layer 11 could not be filled with the second crystal grains 42 sufficiently, and the resistance and insulation of the dielectric layer 11 were not improved. In addition, since the layer thickness occupancy ratio of Comparative Examples 2 to 6 was 0%, the resistance and insulation of the dielectric layer 11 were not improved.

In the present specification, the multilayer ceramic capacitor 100 is described as an example of the multilayer ceramic electronic component, but the multilayer ceramic electronic component to which the above configuration is applied is not limited to this. Other examples of the multilayer ceramic electronic component include a multilayer ceramic varistor and a multilayer ceramic thermistor.

The present invention is not limited to the specific embodiments, and various modifications and changes are possible within the scope of the gist of the present invention described in the claims.

What is claimed is:

1. A multilayer ceramic electronic component comprising:
internal electrode layers facing each other in a predetermined direction;
dielectric layers laminated between the internal electrode layers; and
a pair of external electrodes electrically connected to the internal electrode layers,
wherein at least one of the dielectric layers includes a first crystal grain as a main component ceramic having a perovskite structure represented by a general formula ABO₃, and a second crystal grain whose main component is a barium titanate complex oxide in which an elemental ratio of barium to titanium is 0.70 or less, and
wherein the second crystal grain is in contact with at least one of a pair of the internal electrode layers sandwiching the at least one of the dielectric layers.

2. The multilayer ceramic electronic component according to claim 1, wherein
the second crystal grain has a size of 80% or more of a thickness of a cross section of the at least one of the dielectric layers along the predetermined direction.

3. The multilayer ceramic electronic component according to claim 1, wherein
the second crystal grain is at least one selected from BaTi₂O₅, BaTi₄O₉, BaTi₅O₁₁, BaTi₆O₁₃, Ba₄Ti₁₁O₂₆, Ba₄Ti₁₂O₂₇, Ba₄Ti₁₃O₃₀, or Ba₆Ti₁₇O₄₀.

4. The multilayer ceramic electronic component according to claim 1, wherein
the first crystal grain is barium titanate.

5. The multilayer ceramic electronic component according to claim 1, wherein
the second crystal grain is in contact with both of the pair of the internal electrode layers sandwiching the at least one of the dielectric layers.

6. The multilayer ceramic electronic component according to claim 1, wherein
a width of a contact region of the second crystal grain with respect to the pair of the internal electrode layers in a direction substantially perpendicular to the predetermined direction is 50 to 500 μm.

7. The multilayer ceramic electronic component according to claim 1, wherein
a thickness of a cross section of each of the dielectric layers is 0.4 μm or less.
